(19) United States
(12) Patent Application Publication
(10) Pub. No.: US 2006/0039745 A1
(43) Pub. Date: Feb. 23, 2006

(54) Pocketed storage container

(76) Inventor: Cheryl Menders, Rancho Palos Verdes, CA (US)

Correspondence Address: Henry M. Bissell, Esq., Suite 106, 6820 La Tijera Boulevard, Los Angeles, CA, 90045, US

(21) Appl. No.: 11/138,578

(22) Filed: May 26, 2005

Related U.S. Application Data
(60) Provisional application No. 60/603,869, filed on Aug. 23, 2004.

(51) Int. Cl. B42F 13/00

(52) U.S. Cl. 402/79

(57) ABSTRACT

A device for use in an organizational system for facilitating the preparation of layouts which are to be included in a scrapbook. The device has a plurality of pockets of different sizes which are strategically placed to accommodate various items to be included in the scrapbook. Two outer pockets mounted on opposing surfaces of the device are staggered to facilitate the stacking of the items for conserving space.

This Complete Application claims priority from Provisional Application Ser. No. 60/603,869, filed Aug. 23, 2004.

### BACKGROUND OF THE INVENTION

1. Field of the Invention

The present invention generally relates to a specially designed storage container and, more particularly, to such a container which is specifically adapted to facilitate the practice of the hobby of “scrapbooking”.

2. Description of the Related Art

The hobby of customizing scrapbooks, or “scrapbooking”, can require a variety of supplies. Organization of such supplies has often required different storage devices or methods, some of which are inconvenient or at least not ideal for such users, or “scrapbookers”. For example, a scrapbooker typically needs to store, and have easy access to, many items including specialty paper of odd size, small stickers, floppy disks and/or compact disks containing clip art, die cuts, gloves, tapes, acid free plastic cover sheets and photo corners, photographs, etc. Oftentimes the scrapbooker has turned to file folders and organizers which are made for entirely different purposes.

File folders and organizers specifically adapted to organizing materials for scrapbooking need features not typically found in prior file folders and organizers. Prior devices of this kind were developed with different purposes in mind. Scrapbooks have been developed over the years which allow persons to arrange and store collectible items for convenient viewing. For example, some scrapbooks have included pages upon which photographs could be attached. Other scrapbooks have provided other features, such as pockets for storing items that a person may wish to later take out and examine. In more recent years, great interest has developed in customizing scrapbooks using art paper, stickers, die cut shapes and the like. Thus, customized scrapbook pages can be created that are specific to certain events or circumstances; and artistic and ornamental elements can be incorporated which enhance the presentations of the subject matter which a scrapbook page is intended to communicate or commemorate.

In many instances, ordinary expanding legal or letter size file folders can be used for the storing of scrapbooking items. However, these do not usually conveniently accommodate 12×12 inch paper, which is a standard size used in scrapbooking, so as to protect it from damage and make it readily available.

It is recognized that it would be advantageous to develop a scrapbooking organizer that is convenient to use, has a plurality of pockets for storing scrapbook elements, is sized to accommodate standard scrapbooking materials, including 12×12 inch sheets, and is so configured that a plurality of the organizers can be stacked one on top of another or mounted in a scrapbook while occupying a minimum of space.

### SUMMARY OF THE INVENTION

One particular arrangement in accordance with the invention is constructed to satisfy these needs. It comprises a pair of mounting sheets, each bearing an expandable pocket mounted along approximately one-half of the sheet. Together they form a sleeve with three sections for storing items for scrapbooking. These sheets are joined in a back-to-back orientation with the half-size pockets situated in a staggered configuration on the outer surfaces of the sheets, displaced from each other vertically. The sheet with its pocket in the lower half is defined as the front sheet, and the sheet with its pocket occupying the upper half of its sheet is the back sheet. Between the front and back sheets is a third pocket large enough to receive and store large scrapbook items such as photographs or the 12×12 inch pads of paper on which the scrapbook layouts are assembled. Preferably, the two mounting sheets are fabricated from a single sheet having a left-to-right dimension which is twice the width of a single sheet. The wider sheet is folded vertically in the middle to establish two mounting sheets with the fold edge forming the right-hand edges of the front sheet and of the central pocket. The central pocket is sealed along its bottom edge and the left-hand edges of the sheets are sealed along a vertically oriented margin strip approximately 1½ inches in width. This strip is punched with three holes which are spaced to match the dimensions of an ordinary three-ring, 12-inch binder which constitutes the scrapbook.

### BRIEF DESCRIPTION OF THE DRAWINGS

A better understanding of the present invention may be realized from a consideration of the following detailed description, taken in conjunction with the accompanying drawings, in which:

FIG. 1 is a schematic side view of one particular arrangement in accordance with the present invention;

FIG. 2 is a front elevation of the arrangement of FIG. 1;

FIG. 3 is a schematic view showing a pair of invention embodiments mounted in a three-ring binder on opposite sides of the central binder portion;

FIG. 4 is a schematic view, partially broken away, of a portion of the arrangement of FIG. 1 containing a pocket and a closure; and

FIG. 5 is a schematic view of the arrangement of FIG. 1 showing a central pocket open to receive items for storage therein.

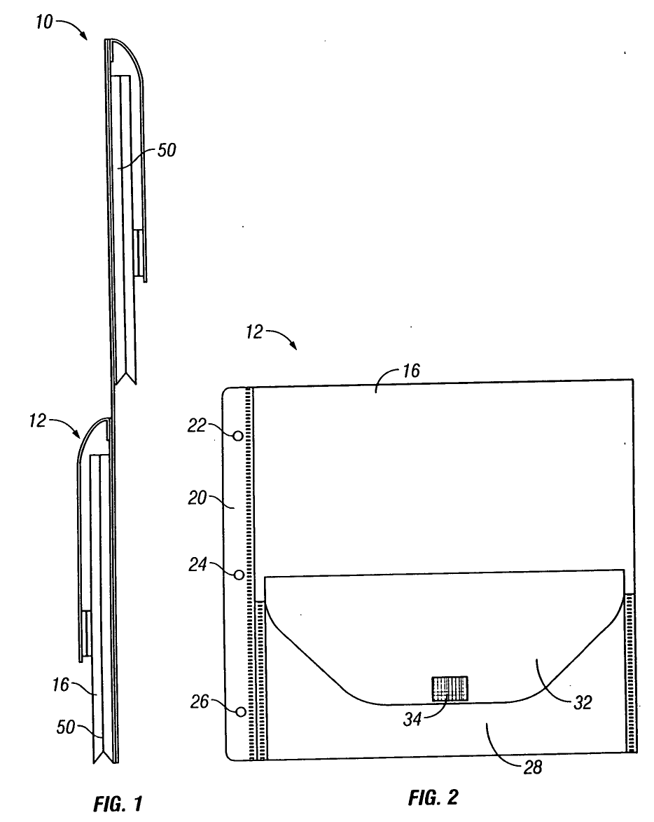

### DESCRIPTION OF THE PREFERRED EMBODIMENTS

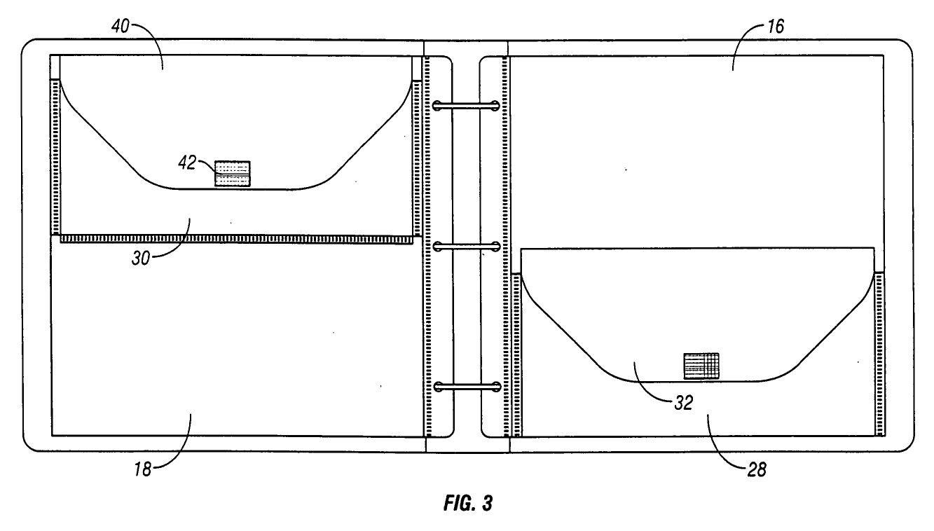

As shown in the drawings, one particular arrangement in accordance with the invention comprises a sleeve 10 fabricated by folding a master sheet vertically along an edge 14 to form a front portion or sheet 16 and a rear portion or sheet 18 (FIG. 3). The two portions are sealed along the left-hand side to form a margin 20 approximately 1½ inches wide and having three holes 22, 24 and 26 suitably spaced to match the rings in a three-ring binder or scrapbook. Each of the sleeve portions has a pocket such as 28 attached thereto by suitable means such as by adhesive, plastic or ultrasonic welding, or by other ways known in the art for securing plastic surfaces together. The pocket 28, mounted on the front sleeve portion 16 is located in the lower half of the sheet. The pocket 30 is affixed to the rear sheet 18 in the upper half of the sheet.

A flap 32 is hingedly connected to the top edge of the first pocket 28. It is provided with at least one hook-and-loop fastener 34 on the inner side of the flap 32 and the outer surface of the pocket 28 for releasably fastening the flap 32 in the closed position. Similarly, the pocket 30 is provided with a flap 40 having the same type of hook-and-loop fastener 42 mounted on the inner surface of the flap 40 and the outer surface of the pocket 30. The first pocket 28 is mounted to the front sheet 16 in the lower half thereof. The second pocket 30 is mounted to the rear sheet 18 in the upper half thereof. Thus, when adjacent sleeves 12 are stacked together in sets or within a scrapbook, the first and second pockets avoid interference with each other (see FIG. 3).

The device 10 may be fabricated of any suitable tough, plastic film, such as polyethylene, polyester, triacetate or, preferably, polypropylene. The material is acid free and PVC free so that photographs and other items placed in the pockets will not be harmed by reacting with the plastic.

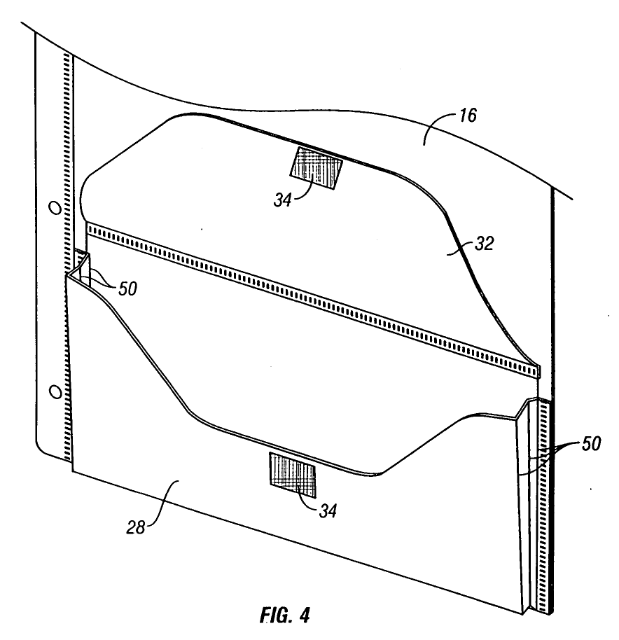

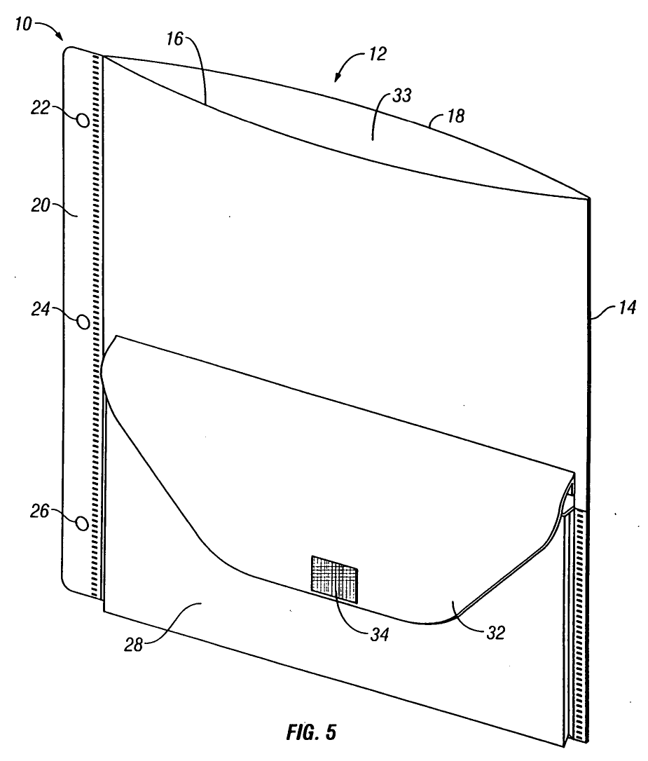

Each of the first and second pockets 28, 30, is formed with side gussets 50 which allow the pockets to expand as items are stuffed into the pockets. FIG. 4 shows the front sheet 16, partially broken away, with the pocket 28 mounted thereon. The purpose of FIG. 4 is to show the pocket 28 with the flap 32 raised and the pocket 28 pulled open to receive items for storage therein. In this configuration, the gussets 50 are expanded to allow the pocket to expand.

A third pocket is formed between the front and back sheets 16, 18 as a center pocket 33. The dimensions of the pocket 33 are approximately 12¼×12¼, designed for storing 12″×12″, paper which is the size commonly used in scrapbooking.

Although there have been described hereinabove various specific arrangements of a POCKETED STORAGE CONTAINER in accordance with the invention for the purpose of illustrating the manner in which the invention may be used to advantage, it will be appreciated that the invention is not limited thereto. Accordingly, any and all modifications, variations or equivalent arrangements which may occur to those skilled in the art should be considered to be within the scope of the invention as disclosed herein.

What is claimed is:

1. A scrapbook organizer comprising a pair of mounting sheets adjacent one another and joined peripherally along three sides to create a sleeve therebetween, each of said mounting sheets having mounted upon it a pocket for containing scrapbooking resources, said pockets being vertically offset from one another to facilitate efficient stacking.

2. The scrapbook organizer of claim 1, wherein each of said pockets is approximately one-half the size of said mounting sheets.

3. The scrapbook organizer of claim 1, wherein each of said pockets further comprises means for expanding to provide greater capacity.

4. The scrapbook organizer of claim 1, wherein each of said pockets further comprises a hinged flap for retaining the contents of said pocket.

5. The scrapbook organizer of claim 4, further comprising means for releasably securing each hinged flap to a corresponding pocket for retaining the contents of said pocket therein.

6. The scrapbook organizer of claim 1, wherein said mounting sheets are peripherally joined so as to form along a vertical side a peripheral margin strip of sufficient width to permit retention of said organizer within a scrapbook.

7. The scrapbook organizer of claim 6, wherein the vertical peripheral margin strip is perforated with a plurality of holes spaced to correspond with the pattern of rings in a ring binder.

8. A scrapbook organizer comprising:
a. A front mounting sheet having an inside face and an outside face;
b. A rear mounting sheet having an inside face and an outside face;
c. A storage sleeve created by arranging the front and rear mounting sheets with their inside faces adjacent and peripherally joined along two side edges and a bottom edge;
d. A margin strip formed along one vertical side of the joined mounting sheets, having a plurality of holes punched therethrough and spaced to correspond to the rings or posts of a binder;
e. A pair of pockets each having a flap for retaining the contents of the pocket, wherein each pocket is approximately one-half the size of a mounting sheet and wherein a first pocket is joined to the lower half of said front mounting sheet and a second pocket is joined to the upper half of said rear mounting sheet;
f. Means for releasably securing said flaps to corresponding pockets;
g. Means for joining said pockets and said mounting sheets together; and
h. Means for expanding the capacity of said pockets.

9. The scrapbook organizer of claim 8, wherein said releasable securing means comprises hook-and-loop type fasteners such as Velcro™.

10. The scrapbook organizer of claim 8, wherein said joining means comprises welding.

11. The scrapbook organizer of claim 8, wherein said joining means comprises adhesive.

12. A scrapbook organizer comprising:
a. A generally rectangular planar sheet having a greater latitudinal dimension and a lesser longitudinal dimension, wherein said planar sheet is folded approximately in half along a longitudinal axis to create a front mounting sheet and a rear mounting sheet;
b. A margin strip created by joining the longitudinal peripheries of said folded planar sheet;
c. A storage sleeve created by peripherally joining the latitudinal lower peripheries of said folded planar sheet;
d. A pair of pockets wherein each pocket is approximately one-half the size of a mounting sheet and wherein each pocket has a flap for retaining the pocket contents.

13. The scrapbook organizer of claim 12, wherein one of said pair of pockets is joined to the lower half of said front mounting sheet and the other one of said pair of pockets is joined to the upper half of said rear mounting sheet.

14. The scrapbook organizer of claim 12, wherein said pockets are expandable.

15. The scrapbook organizer of claim 14, wherein said expandable pockets further comprise side gussets.

16. The scrapbook organizer of claim 12, wherein said margin strip is configured to attach said organizer in a scrapbook binder.

17. The scrapbook organizer of claim 16, wherein said margin strip is approximately three-fourths of any inch wide.

18. The scrapbook organizer of claim 16, wherein said margin strip provides a plurality of holes therethrough and arranged to correspond to the retaining rings or posts of a scrapbook binder.

19. The scrapbook organizer of claim 12, wherein said organizer is constructed from acid free, poly-vinyl chloride (PVC) free materials.

20. The scrapbook organizer of claim 12, wherein said organizer is constructed from translucent materials.
